(19) United States
(12) Patent Application Publication
(10) Pub. No.: US 2007/0155321 A1
(43) Pub. Date: Jul. 5, 2007

(54) METHOD OF LOCKING AN INPUT DEVICE

(75) Inventors: Kuan-Hong Hsieh, Shenzhen (CN); Xiao-Guang Li, Shenzhen (CN); Robert Han Liu, Shenzhen (CN); Wen-Chuan Lian, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,828

(22) Filed: Oct. 5, 2006

(30) Foreign Application Priority Data
Dec. 16, 2005 (CN) 200510120713.2

(51) Int. Cl. H04B 1/06

(52) U.S. Cl. 455/26.1

(57) ABSTRACT

An input device with a lock mechanism is provided. The input device has a storage unit, a pressure sensor, a microcontroller, and a locking unit. The storage unit is for storing information, typically private, sensitive files/documents. The pressure sensor is for generating pressure sensing signals if pressed. The microcontroller is for scanning the pressure sensing signals in real time, and generating and transmitting a lock signal to the locking unit. The locking unit is signaled to perform a lock operation on the storage unit in response to the lock signal, thereby preventing unauthorized access to the information of the storage unit. A related method is also provided.

### TECHNICAL FIELD

The present invention relates to input devices and methods therefor, and particularly to an input device with a lock mechanism and locking method used in the input device.

### GENERAL BACKGROUND

Along with continual development of the information industry, computers have penetrated into everyday lives of people whether work related or personal related. Computer peripheral devices such as mice and memory devices have also become non-excludable products in computer operations.

When a user operates a computer to perform data processing, a mouse plays an important role when using a graphical user interface of the computer. Through an accurate cursor control provided by the mouse, the user can maneuver information on the screen performing actions such as, selection, drag, and execution, thereby performing data editing, data cutting or pasting, documents opening or closing, and so on.

In an unrelated aspect, it is also necessary to store various kinds of electronic data in peripheral devices. Therefore, data storage devices such as flash memories, electronic erasable programmable read-only memories (EEPROMs), or magnetic recording media were developed to store the various kinds of electronic data. For example, various kinds of memory cards allow users be able to conveniently exchange various kinds of files and documents between computers.

However, in prior arts, the cursor function of the mouse and the data storage function of the memory belong to separate peripheral devices. Nevertheless, the independent nature of these two functions may be troublesome to people, typically, someone who is often out of home or office. When people are out, they are required to carry many computer peripheral devices associated with a portable computer such as, for example, the mouse, the data storage device, and the like. As a result, the more computer peripheral devices needed, the higher possibility people may forget to bring the peripheral devices. In other words, the separation of a mouse function and a storage function creates many inconveniences for people.

Therefore, a mouse capable of storing data, namely a combination of the conventional mouse and the conventional data storage device, has been introduced recently. This mouse can be used for data access when being used as a regular mouse. While this mouse is capable of precluding the above problem in portability, another problem has been encountered that, data stored in the mouse, that are mostly private and sensitive information, however, has no mechanism to prevent unauthorized access to the data.

What is needed, therefore, is an input device and method of locking the input device, which can enable the user to promptly, conveniently lock the input device, thereby preventing unauthorized access to the input device.

### SUMMARY

An input device with a lock mechanism is provided. The input device has a storage unit, a pressure sensor, a microcontroller, and a locking unit. The storage unit is for storing information. The pressure sensor is for generating pressure sensing signals if pressed thereon. The microcontroller is for scanning the pressure sensing signals in real time, and generating a lock signal if not detecting the pressure sensing signals. The locking unit is signaled to lock the storage unit in response to the lock signal from the microcontroller, thereby preventing unauthorized access to the information of the storage unit.

A method of locking an input device is also provided, wherein the input device has a storage unit and a pressure sensor, the pressure sensor being for generating pressure sensing signals if pressed. The method includes the steps of: (a) scanning the pressure sensing signals in real time; (b) generating a lock signal if not detecting the pressure sensing signals; and (c) locking the storage unit according to the lock signal, thereby preventing unauthorized access to the storage unit.

Other advantages and novel features will be drawn from the following detailed description with reference to the attached drawing, in which:

### BRIEF DESCRIPTION OF DRAWINGS

FIG. 1 is an exemplary schematic diagram of a hardware infrastructure of an input device capable of locking a storage unit therein in accordance with a preferred embodiment of the present invention; and

FIG. 2 is a flowchart of a preferred method for locking the storage unit of the input device of FIG. 1.

### DETAILED DESCRIPTION

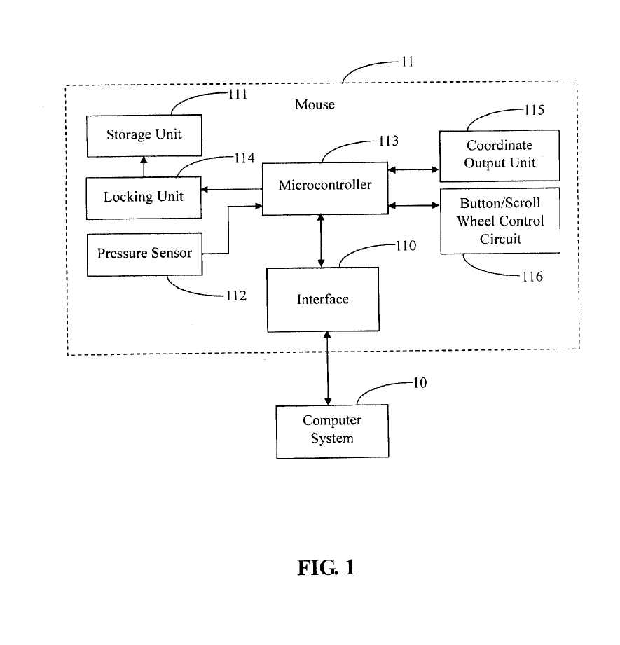

FIG. 1 is an exemplary schematic diagram of a hardware infrastructure of an input device in accordance with a preferred embodiment of the present invention. The input device 11 is a peripheral device, typically a pointing device such as, for example, a mouse, a joy stick, a track ball, etc, which not only enables control of a cursor on a display of a computer system 10 connected thereto, but can also store data, and further also generates a lock signal to lock itself for preventing unauthorized access.

In this exemplary embodiment, the mouse is provided as an example. The mouse 11 has an interface 110, a storage unit 111, a pressure sensor 112, a microcontroller 113, a locking unit 114, a coordinate output unit 115, and a button/scroll wheel control circuit 116.

The interface 110 is for performing data communication between the mouse 11 and the computer system 10. Consequently, the interface 110 can be any appropriate communication media such as, for example, a Universal Serial Bus (USB) interface, a PS/2 (Personal System/2) interface, and so on.

The storage unit 111 is for storing information. The information includes various kinds data, typically private files/documents.

The coordinate output unit 115 is for outputting coordinates corresponding to a movement of the mouse 11 to the microcontroller 113, and the microcontroller 113 thereupon transmits the coordinates to the computer system 10 through the interface 110. The button/scroll wheel control circuit 116 is for controlling operations of both buttons and scroll wheel of the mouse

The pressure sensor 112 is preferably configured at the bottom of the mouse 11 for sensing pressure thereon. Accordingly, the pressure sensor 112 is able to generate pressure sensing signals if the mouse 11 is kept flatwise on a support surface, whereas, the pressure sensor 112 does not generate the pressure sensing signals if the mouse 11 is not kept flatwise on the support surface. For example, if the mouser 11 is placed sideways or is in an overturned state, the pressure sensor 112 is not pressured, thus not generating the pressure sensing signals.

The microcontroller 113 scans the pressure sensing signals from the pressure sensor 112 in real time. In this exemplary embodiment, if a duration of not detecting the pressure sensing signals reaches a predetermined value, the microcontroller 113 generates and transmits a lock signal to the locking unit 114. After receiving the lock signal, the locking unit 114 performs a lock operation on the storage unit 111, thereby preventing unauthorized access to the storage unit 111.

Therefore, a user of the mouse 11 can promptly and conveniently lock the storage unit 111 through a simple operation on the mouse 11 such as, for example, turning over the mouse 11 or placing the mouse 11 in sideways.

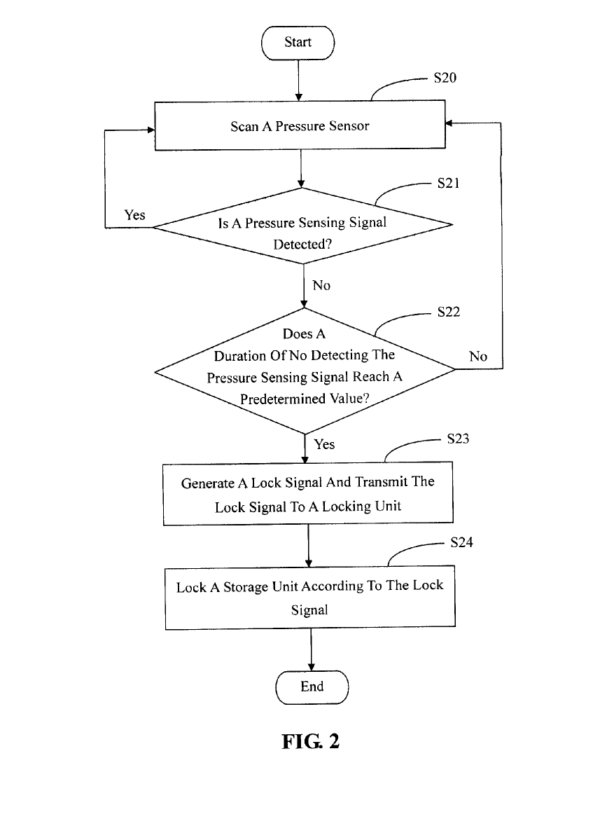

FIG. 2 is a flowchart of a preferred method for locking the storage unit 111 of the mouse 11 of FIG. 1. In step S20, the microcontroller 113 scans the pressure sensing signals from the pressure sensor 112 in real time.

In step S21, the microcontroller 113 determines whether it detects the pressure sensing signals. If the microcontroller 113 detects the pressure sensing signals, the procedure returns to step S20 described above.

If the microcontroller 113 does not detect the pressure sensing signals, in step S22, the microcontroller 113 determines whether a duration of not detecting the pressure sensing signals reaches a predetermined value. If the duration of not detecting the pressure sensing signals does not reach the predetermined value, the procedure returns to step S20 described above.

If the duration of not detecting the pressure sensing signals reaches the predetermined value, in step S23, the microcontroller 113 generates and transmits the lock signal to the locking unit 114.

In step S24, the locking unit 114 is signaled to perform the lock operation on the storage unit 111 in response to the lock signal, thereby preventing unauthorized users to access the information stored in the storage unit 111, and the procedure is finished.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An input device with a lock mechanism, the input device comprising:
a storage unit for storing information;
a pressure sensor for generating pressure sensing signals if pressed;
a microcontroller for scanning the pressure sensing signals in real time, and generating a lock signal if not detecting the pressure sensing signals; and
a locking unit for locking the storage unit according to the lock signal from the microcontroller.

2. The input device according to claim 1, wherein the pressure sensor is configured at the bottom thereof.

3. The input device according to claim 2, wherein the microcontroller generates the lock signal if a duration of not detecting the pressure sensing signals reaches a predetermined value.

4. A method of locking an input device, wherein the input device has a storage unit and a pressure sensor, the pressure sensor being configured for generating pressure sensing signals if pressed, the method comprising the steps of:
scanning the pressure sensing signals in real time;
generating a lock signal if not detecting the pressure sensing signals; and
locking the storage unit according to the lock signal, thereby preventing unauthorized access to the storage unit.

5. The method according to claim 4, wherein the generating step further comprises the step of: generating the lock signal if a duration of not detecting the pressure sensing signals reaches a predetermined value.
